(19) United States
(12) Patent Application Publication
(10) Pub. No.: US 2016/0270442 A1
(43) Pub. Date: Sep. 22, 2016

(54) ATOMIZER AND ELECTRONIC CIGARETTE

(71) Applicant: Qiuming Liu, Guangdong (CN)

(72) Inventor: Qiuming Liu, Guangdong (CN)

(21) Appl. No.: 14/364,214

(22) PCT Filed: Jan. 17, 2014
(86) PCT No.: PCT/CN2014/070779

§ 371 Date: Jun. 10, 2014

(30) Foreign Application Priority Data
Nov. 18, 2013 (CN) 201320729463.2
Dec. 31, 2013 (CN) 201320893439.2

(51) Int. Cl. A24F 47/00; H05B 3/14; H05B 3/00

(52) U.S. Cl. CPC A24F 47/008; H05B 3/0014; H05B 3/141

(57) ABSTRACT

An atomizer includes a connector, a heat generation mechanism, an air pipe, a liquid container, a fixing sleeve, a paster and a mouthpiece cover. The connector is provided with at least one inclined air inlet communicated with an outer periphery of the connector and the air pipe; at least one groove is provided on the outer periphery of the connector at a portion where the connector and the liquid container are connected; the liquid container is a transparent non-metallic member, the fixing sleeve is provided with an observation window, and the paster is provided with a hole corresponding to the observation window; the mouthpiece cover is provided with a cigarette liquid collecting groove; and a liquid inlet slit communicated with the cigarette liquid collecting groove is provided between the air pipe and the mouthpiece cover, and the liquid inlet slit has a width L no less than 0.4 mm.

This application is the national phase of International Application No. PCT/CN2014/070779, titled “ATOMIZER AND ELECTRONIC CIGARETTE”, filed on Jan. 17, 2014, which claims the benefit of priorities to Chinese patent application No. 201320729463.2 titled “ELECTRONIC CIGARETTE AND ATOMIZING DEVICE THEREOF” and filed with the Chinese State Intellectual Property Office on Nov. 18, 2013 and Chinese patent application No. 201320893439.2 titled “ATOMIZER AND ELECTRONIC CIGARETTE” and filed with the Chinese Intellectual Property Office on Dec. 31, 2013, all of which applications are incorporated herein in their entireties by this reference.

### FIELD

The present application relates to the technical field of electronic cigarettes, and in particular to an atomizer and an electronic cigarette.

### BACKGROUND

An electronic cigarette is a common electronic simulation cigarette production, which mainly includes an atomizer and a battery assembly. The battery assembly supplies electric energy for the atomizer, thus a heating wire in the atomizer may generate heat to vaporize cigarette liquid in a liquid guiding wick of the atomizer to emit smoke, thereby simulating the real cigarette.

Reference is made to FIGS. 1 and 2, wherein FIG. 1 is a structural view of an electronic cigarette on the market, and FIG. 2 is an enlarged view of portion A in FIG. 1. As shown in the Figures, the electronic cigarette includes an atomizer a and a battery assembly b which are detachably connected. As shown in the Figures, the atomizer a of the existing electronic cigarette has the following disadvantages.

1. An airflow path is indicated by an arrow in FIG. 1, the airflow mainly enters into the atomizer a via an air inlet d at a lateral surface of a connector c, then goes around to an end surface of the connector c, and finally enters into a smoke passage e in the atomizer via a central hole c1 of the connector c. Since the airflow path is complicated and there are many barriers during the flowing of the airflow, loud noises are generated during the operation of the electronic cigarette.

2. A liquid container f of the atomizer a is formed by plastic injection molding, and the liquid container f and the connector c are connected and fixed by hot pressing or glue. In a case that the liquid container f is pressed or pushed by an external force, the liquid container f is prone to fall off due to deformation or poor adhesion.

3. A surface of one end of the liquid container f which is away from the connector is directly exposed, thus the cigarette liquid may enter into the mouth of a user through the smoke passage e in the liquid container f, which may cause harm to health of the user.

Therefore, in view of this, an important technical issue to be solved at present by those skilled in the art is to improve the structure of the atomizer to address the above issues.

### SUMMARY

An atomizer and an electronic cigarette are provided in the present application, wherein a groove and an inclined air inlet are provided on a connector, and a mouthpiece cover and a liquid condensation groove are further provided, thereby effectively reducing noise, and fixing a liquid container and at the same time preventing liquid from entering into the mouth of a user.

An atomizer according to the present application includes a connector, a heat generation mechanism, an air pipe, a liquid container, and a mouthpiece cover, wherein the connector and the mouthpiece cover are, respectively, provided at two ends of the liquid container, and one end of the connector is inserted into the liquid container, and the atomizer further includes a fixing sleeve sleeved on the liquid container and a paster adhered on the fixing sleeve;

the connector is provided with at least one inclined air inlet communicated with an outer periphery of the connector, and the inclined air inlet is communicated with the air pipe;

at least one groove is provided on the outer periphery of the connector at a portion where the connector and the liquid container are connected;

the liquid container is a transparent non-metallic member, the fixing sleeve is provided with an observation window, and the paster is provided with a hole corresponding to the observation window;

the mouthpiece cover is provided with a cigarette liquid collecting groove; and

a liquid inlet slit communicated with the cigarette liquid collecting groove is provided between the air pipe and the mouthpiece cover, and the liquid inlet slit has a width L no less than 0.4 mm.

Preferably, the fixing sleeve is sleeved on the connector and the liquid container.

Preferably, an angle formed between the inclined air inlet and an axial direction of the connector is greater than 20 degrees and less than 70 degrees.

Preferably, the heat generation mechanism includes a liquid guiding wick, a heating wire, a liquid guiding cotton, and a ceramic supporting seat, the liquid guiding cotton is configured to temporarily store cigarette liquid adsorbed from the liquid container, the liquid guiding wick is configured to transfer the cigarette liquid on the liquid guiding cotton to the heating wire for atomization, and the heating wire is fixed on the ceramic supporting seat and is electrically connected to the connector.

Preferably, at least one position limiting groove configured to limit a position of the fixing sleeve is provided on the connector at a portion where the connector and the fixing sleeve are connected.

Preferably, the groove or the position limiting groove is an annular groove.

Preferably, the width L of the liquid inlet slit is not less than 1 mm and not greater than 3 mm.

Preferably, the observation window is a rectangular window; and

two ends of the rectangular window are arc-shaped.

Preferably, the rectangular window is provided with a graduated scale.

An electronic cigarette is also provided in the present application, and includes an atomizer and a battery assembly which are connected, and the atomizer is the atomizer according to any one of the above solutions.

The atomizer and the electronic cigarette according to the present application have the following beneficial effects.

1. At least one inclined air inlet communicated with the air pipe is provided on the connector, thus when entering into the atomizer via the inclined air inlet, the airflow may encounter less barriers, thereby effectively reducing noise.

2. At least one groove is provided on the outer periphery of the connector at a portion where the connector and the liquid container are connected, the fixing sleeve is made of non-metallic material, and the fixing sleeve sleeved on the liquid container may press the inner wall of the liquid container made of non-metallic material to embed the inner wall of the liquid container in the groove, thereby improving the reliability of the connection between the connector and the liquid container.

3. The liquid container is arranged as a transparent non-metallic member, the observation window is provided on the fixing sleeve, and the paster adhered to the fixing sleeve is provided with the hole corresponding to the observation window, thus the quantity of the cigarette liquid in the liquid container may be observed, which may facilitate refueling or replacing the atomizer.

4. The cigarette liquid collecting groove is provided on the mouthpiece cover, the liquid inlet slit communicated with the cigarette liquid collecting groove is provided between the air pipe and the mouthpiece cover, and the width L of the liquid inlet slit is not less than 0.4 mm, and such structure may better ensure that the cigarette liquid drop condensed on the air pipe after the cigarette liquid is atomized may flow into the cigarette liquid collecting groove via the liquid inlet slit, so as to prevent the liquid from entering the mouth of the user.

### BRIEF DESCRIPTION OF THE DRAWINGS

For more clearly illustrating embodiments of the present application or the technical solution in the conventional technology, drawings referred to describe the embodiments or the conventional technology is briefly described hereinafter. Apparently, the drawings in the following description are only a few of embodiments of the present application, and for those skilled in the art other drawings may be obtained based on these drawings without any creative efforts.

FIG. 1 is a sectional view of a conventional electronic cigarette;

FIG. 2 is an enlarged view of portion A in FIG. 1;

FIG. 3 is a sectional view of an atomizer according to the present application;

FIG. 4 is a schematic view showing the structure of a connector in the atomizer according to the present application;

FIG. 5 is a schematic view showing the structure of the connector in the atomizer according to the present application, viewed from another angle;

FIG. 6 is an exploded view showing the structure of the atomizer according to the present application; and

FIG. 7 is a schematic view showing the structure of a battery rod and an atomizer of an electronic cigarette according to the present application.

### DETAILED DESCRIPTION OF THE PREFERRED EMBODIMENTS

An atomizer and an electronic cigarette are provided in the present application, wherein a groove and an inclined air inlet are provided on a connector, and a liquid inlet slit communicated with a cigarette liquid collecting groove of a mouthpiece cover and having a width L no less than 0.4 mm is formed between an air pipe and the mouthpiece cover, thereby effectively reducing noise, and fixing a liquid container reliably and at the same time preventing liquid from entering into the mouth of a user.

The technical solutions in the embodiments of the present application are described clearly and completely hereinafter in conjunction with the drawings in the embodiments of the present application. Apparently, the described embodiments are only a few of rather than all embodiments of the present application. Based on the embodiments in the present application, all of other embodiments, made by the person skilled in the art without any creative efforts, fall into the scope of the present application.

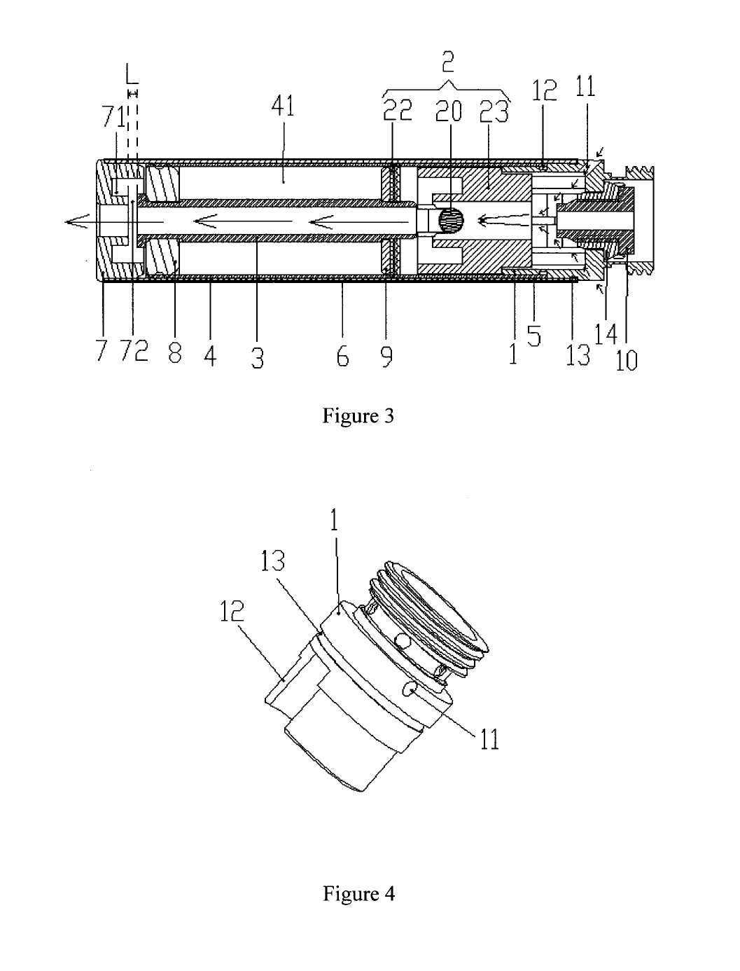

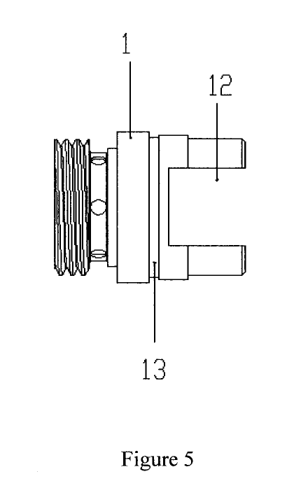

Referring to FIGS. 3 to 7, an atomizer according to the present application is configured to form an electronic cigarette in combination with a battery assembly, and includes a connector 1, a heat generation mechanism 2, an air pipe 3, a liquid container 4, a fixing sleeve 5, a paster 6, and a mouthpiece cover 7. The connector 1 is configured to connect the battery assembly, an electrode 10 and an insulating ring 14 are provided in the connector 1, and the insulating ring 12 is located between the connector 1 and the electrode 10. The connector 1 and the mouthpiece cover 7 are respectively provided at two ends of the liquid container 4, and one end of the connector 1 is inserted into the liquid container 4. The connector 1 is provided with at least one inclined air inlet 11 which is communicated with an outer periphery of the connector 1 and the air pipe 3. The liquid container 4 is a transparent non-metallic member, and in this embodiment, the liquid container 4 is of a transparent tubular structure and made of plastic material. Apparently, the liquid container 4 may be of other structures and made of other materials, as long as it may meet the requirement for containing cigarette liquid, which are not limited herein.

The heat generation mechanism 2 and the air pipe 3 are coaxially provided in the liquid container 4, two ends of the air pipe 3 are respectively provided with a sealing cover 8 and a liquid leaking plate 9, and a liquid storage chamber 41 for storing cigarette liquid is formed by a space surrounded by the liquid container 4, the air pipe 3, the sealing cover 8 and the liquid leaking plate 9. It could be understood that, in other embodiments, the air pipe 3, the sealing cover 8, and the liquid container 4 may be formed integrally, or the air pipe 3 and the liquid container 4 may be formed integrally, which may simplify the production and facilitate assembling.

At least one groove 12 is provided on the outer periphery of the connector 1 at a portion where the connector 1 and the liquid container 4 are connected, and the fixing sleeve 5 is sleeved on the liquid container 4 and is configured to press an inner wall of the liquid container 4 made of non-metallic material to embed the inner wall of the liquid container 4 in the groove 12, thus the connector 1 and the liquid container 4 are reliably connected. The fixing sleeve 5 is provided with an observation window 51, and the paster 6 is adhered to the fixing sleeve 5 and is provided with a hole 61 corresponding to the observation window. The mouthpiece cover 7 is provided with a cigarette liquid collecting groove 71, and a liquid inlet slit 72 communicated with the cigarette liquid collecting groove 71 is formed between the air pipe 3 and the mouthpiece cover 7, and the liquid inlet slit 72 has a width L no less than 0.4 mm.

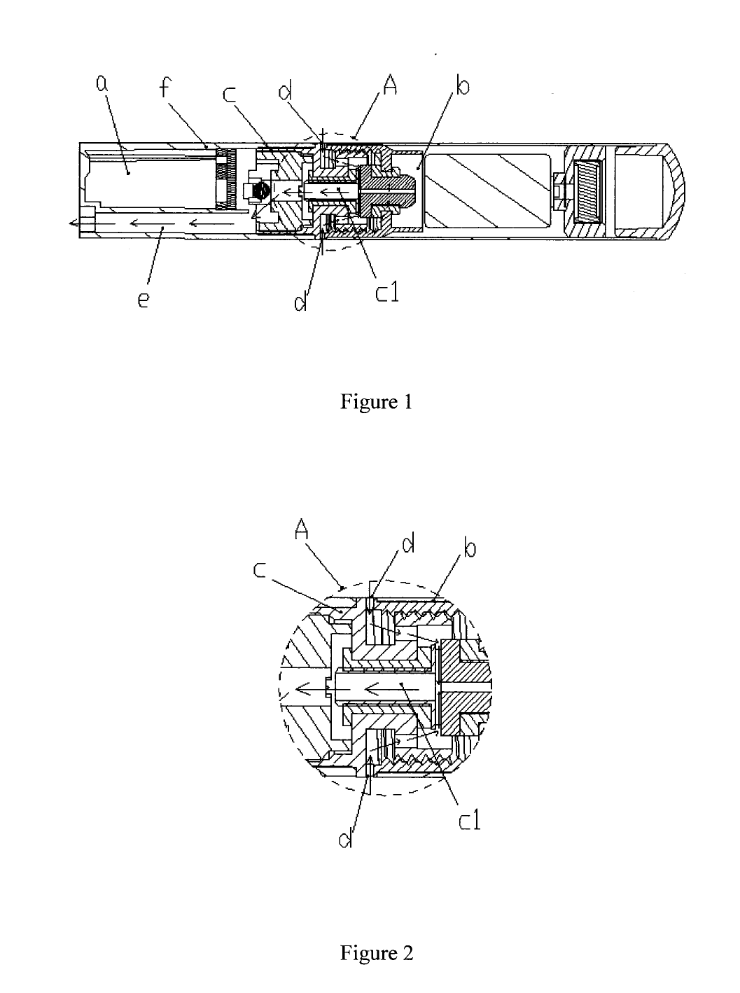

Referring to FIGS. 1 and 3, the airflow path in FIG. 3 is simpler than that in FIG. 1, and the airflow is subjected to a smaller resistance and has a shorter flowing path, thus the inclined air inlet 11 provided on the connector 1 of the atomizer according to the present application may reduce the noise generated during the flowing of the airflow. Referring to FIG. 3, the paster 6 is adhered to the fixing sleeve 5, and since the liquid container 4 is made of non-metallic material, the liquid container 4 is pressed to be deformed in a case that the paster 6 is pulled in a direction towards the mouthpiece cover 7 by an external force. Specifically, the connector 1 is provided with a groove 12, a pressed portion of the liquid container 4 is embedded into the groove 12, and the liquid container 4 is not apt to fall off due to the limiting effect of the groove 12 on the embedded end of the liquid container 4. Since the fixing sleeve 5 is provided with the observation window 51, it's convenient for a user to observe the consumption of the cigarette liquid in the liquid container 4, which may facilitate replacing the atomizer in time. Referring to a reference numeral L in FIG. 3, the mouthpiece cover 7 is provided with a cigarette liquid collecting groove 71, the liquid inlet slit 72 communicated with the cigarette liquid collecting groove 71 is formed between the mouthpiece cover 7 and the air pipe 3, and the width of the liquid inlet slit 72 is not less than 0.4 mm. A thickness of a cigarette liquid drop condensed on the air pipe 3 after the cigarette liquid is atomized is generally around 0.3 mm, and the liquid drop flows towards the mouthpiece cover 7 along with the inhaling airflow, and when passing through the liquid inlet slit 72, the liquid drop flows into the cigarette liquid collecting groove 71 to be stored, thus the liquid may be prevented from entering into the mouth of the user.

Alternatively, the fixing sleeve 5 is sleeved on the connector 1 and the liquid container 4, thus the connector 1, the liquid container 4, and the fixing sleeve 5 may be connected more steady and reliable.

Alternatively, an angle formed between the inclined air inlet 11 and an axial direction of the connector 1 is greater than 20 degrees and less than 70 degrees, that is, an airflow flowing direction of the inclined air inlet 11 should be as close as possible to an airflow flowing direction of the atomizer, so as to reduce the noise.

Alternatively, the heat generation mechanism 2 includes a liquid guiding wick 20, a heating wire 21, a liquid guiding cotton 22, and a ceramic supporting seat 23. The liquid guiding cotton 22 is configured to temporarily store cigarette liquid adsorbed from the liquid storage chamber 41 in the liquid container 4, and the liquid guiding cotton 22 is adhered to one side of the liquid leaking plate 9. The liquid guiding wick 20 is configured to transfer the cigarette liquid on the liquid guiding cotton 22 to the heating wire 21 for atomization, the heating wire 21 is fixed on the ceramic supporting seat 23, and two ends of the heating wire 21 are electrically connected to the connector 1 and the electrode 10, respectively.

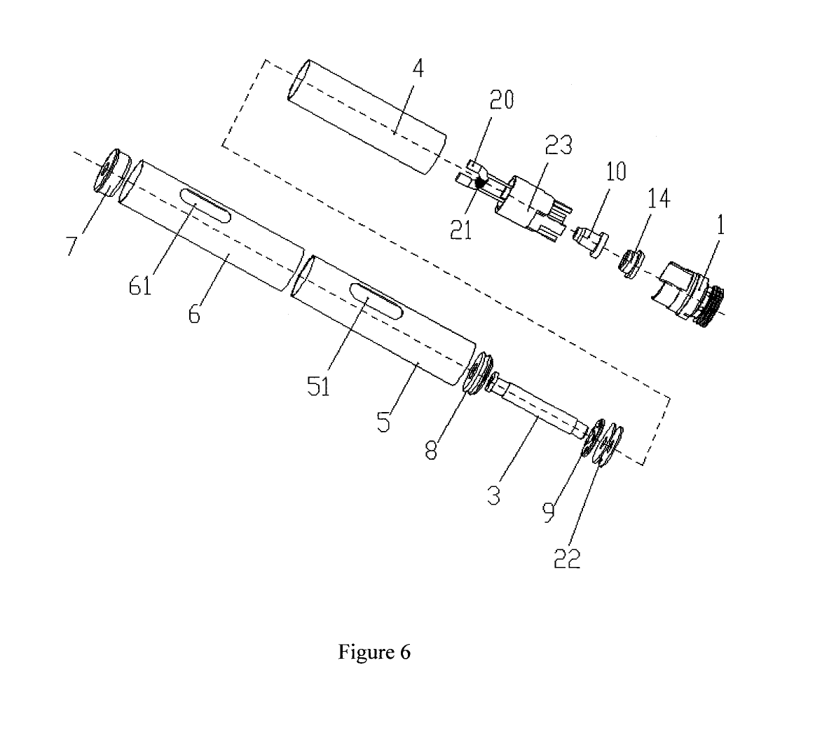

In a conventional heat generation mechanism, the heating wire is generally supported by a silica gel supporting seat, however, since the silica gel has a poor high temperature tolerance, the silica gel supporting seat is prone to be damaged and generate harmful substances when the heating wire has a high temperature. Referring to FIG. 6, the heat generation mechanism 2 according to the present application employs the ceramic supporting seat 23 to support the heating wire 21, thereby effectively addressing the above issue.

Alternatively, at least one position limiting groove 13 configured to limit the position of the fixing sleeve 5 is provided on the connector 1 at a portion where the connector 1 and the fixing sleeve 5 are connected.

Alternatively, the groove 12 or the position limiting groove 13 is an annular groove.

It should be noted that, in a case that the groove 12 or the position limiting groove 13 is a groove of other structures, such as a square groove or a circular groove, the groove 12 or the position limiting groove 13 may be a combination of multiple grooves. In a case that the groove 12 or the position limiting groove 13 is an annular groove, the groove 12 or the position limiting groove 13 may only include one annular groove.

Alternatively, the width L of the liquid inlet slit 72 is not less than 1 mm and not greater than 3 mm.

After being liquefied, the cigarette liquid flows towards the mouthpiece cover 7 through the air pipe 3, and in a case that the width L of the liquid inlet slit 72 is too small, the cigarette liquid may directly pass over the liquid inlet slit 72 and enter into the mouth of the user. Thus the liquid inlet slit 72 should have an appropriate width. Preferably, the width L may be not less than 1 mm and not greater than 3 mm.

Alternatively, the observation window 51 is a rectangular window, and two ends of the rectangular window are both arc-shaped.

Alternatively, the rectangular window is provided with a graduated scale.

Referring to FIG. 6, via the graduated scale on the rectangular window, the user may know about the consumption of the cigarette liquid in the liquid container 4 more visually, thereby facilitating replacing the atomizer in time.

It should be noted that, the specific shape, size, and position of the observation window may be adaptively varied according to the structure of practical products and practical requirements, which are not limited to the rectangular window in this embodiment of the present application and are not limited herein.

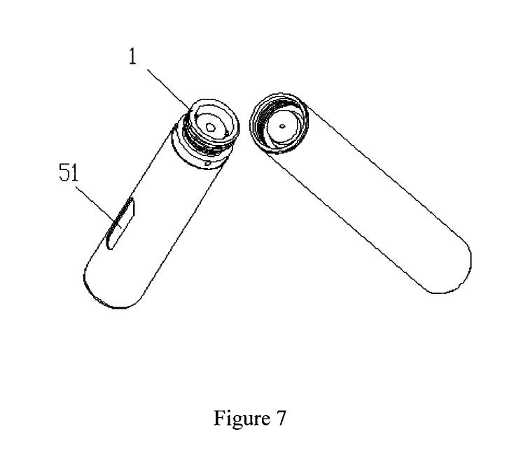

An embodiment of an electronic cigarette according to the present application is described hereinafter. Referring to FIG. 7, the electronic cigarette according to the present application includes an atomizer and a battery assembly which are detachably connected, and the atomizer is the atomizer described above. Since the atomizer of the electronic cigarette has the same structure as that of the atomizer described above, the electronic cigarette may have the same technical effects. The battery assembly is an existing battery assembly, thus will not be described herein.

In conclusion, the atomizer and the electronic cigarette according to the present application have the following beneficial effects.

a. At least one inclined air inlet 11 communicated with the air pipe 3 is provided on the connector 1, thus when entering into the atomizer via the inclined air inlet 11, the airflow may encounter less barriers, thereby effectively reducing noise.

b. At least one groove 12 is provided on the outer periphery of the connector at a portion where the connector 1 and the liquid container 4 are connected, the fixing sleeve 4 is made of non-metallic material, and the fixing sleeve 5 sleeved on the liquid container 4 may press the inner wall of the liquid container 4 made of non-metallic material to embed the inner wall of the liquid container 4 in the groove 12, thereby improving the reliability of the connection between the connector and the liquid container.

c. The liquid container 4 is arranged as a transparent non-metallic member, the observation window 51 is provided on the fixing sleeve 5, and the paster 6 adhered to the fixing sleeve 5 is provided with the hole 61 corresponding to the observation window 51, thus the quantity of the cigarette liquid in the liquid container 4 may be observed, which may facilitate refueling or replacing the atomizer.

d. The cigarette liquid collecting groove 71 is provided on the mouthpiece cover 7, the liquid inlet slit 72 communicated with the cigarette liquid collecting groove 71 is provided between the air pipe 3 and the mouthpiece cover 7, and the width L of the liquid inlet slit 72 is not less than 0.4 mm, and such structure may better ensure that the cigarette liquid drop condensed on the air pipe 3 after the cigarette liquid is atomized may flow into the cigarette liquid collecting groove 71 via the liquid inlet slit 72, so as to prevent the liquid from entering the mouth of the user.

An atomizer and an electronic cigarette provided in the present application are described in detail hereinbefore. The principle and the embodiments of the present application are illustrated herein by a few of examples. The above description of examples is only intended to help the understanding of the method and the idea of the present application. It should be noted that, for the person skilled in the art, modifications and improvements may be made to the present application without departing from the principle of the present application, and these modifications and improvements are also deemed to fall into the scope of the present application defined by the claims.

What is claimed is:

1. An atomizer, comprising a connector, a heat generation mechanism, an air pipe, a liquid container, and a mouthpiece cover, the connector and the mouthpiece cover being, respectively, provided at two ends of the liquid container, and one end of the connector being inserted into the liquid container, wherein the atomizer further comprises a fixing sleeve sleeved on the liquid container and a paster adhered on the fixing sleeve;
the connector is provided with at least one inclined air inlet communicated with an outer periphery of the connector, and the inclined air inlet is communicated with the air pipe;
at least one groove is provided on the outer periphery of the connector at a portion where the connector and the liquid container are connected;
the liquid container is a transparent non-metallic member, the fixing sleeve is provided with an observation window, and the paster is provided with a hole corresponding to the observation window;
the mouthpiece cover is provided with a cigarette liquid collecting groove; and
a liquid inlet slit communicated with the cigarette liquid collecting groove is provided between the air pipe and the mouthpiece cover, and the liquid inlet slit has a width L no less than 0.4 mm.

2. The atomizer according to claim 1, wherein the fixing sleeve is sleeved on the connector and the liquid container.

3. The atomizer according to claim 1, wherein an angle formed between the inclined air inlet and an axial direction of the connector is greater than 20 degrees and less than 70 degrees.

4. The atomizer according to claim 1, wherein the heat generation mechanism comprises a liquid guiding wick, a heating wire, a liquid guiding cotton, and a ceramic supporting seat, the liquid guiding cotton is configured to temporarily store cigarette liquid adsorbed from the liquid container, the liquid guiding wick is configured to transfer the cigarette liquid on the liquid guiding cotton to the heating wire for atomization, and the heating wire is fixed on the ceramic supporting seat and is electrically connected to the connector.

5. The atomizer according to claim 1, wherein at least one position limiting groove configured to limit a position of the fixing sleeve is provided on the connector at a portion where the connector and the fixing sleeve are connected.

6. The atomizer according to claim 5, wherein the groove or the position limiting groove is an annular groove.

7. The atomizer according to claim 1, wherein the width L of the liquid inlet slit is not less than 1 mm and not greater than 3 mm.

8. The atomizer according to claim 1, wherein the observation window is a rectangular window; and
two ends of the rectangular window are arc-shaped.

9. The atomizer according to claim 8, wherein the rectangular window is provided with a graduated scale.

10. An electronic cigarette, comprising an atomizer and a battery assembly which are connected, wherein comprises a connector, a heat generation mechanism, an air pipe, a liquid container, and a mouthpiece cover, the connector and the mouthpiece cover are, respectively, provided at two ends of the liquid container, and one end of the connector is inserted into the liquid container, wherein the atomizer further comprises a fixing sleeve sleeved on the liquid container and a paster adhered on the fixing sleeve;
the connector is provided with at least one inclined air inlet communicated with an outer periphery of the connector, and the inclined air inlet is communicated with the air pipe;
at least one groove is provided on the outer periphery of the connector at a portion where the connector and the liquid container are connected;
the liquid container is a transparent non-metallic member, the fixing sleeve is provided with an observation window, and the paster is provided with a hole corresponding to the observation window;
the mouthpiece cover is provided with a cigarette liquid collecting groove; and
a liquid inlet slit communicated with the cigarette liquid collecting groove is provided between the air pipe and the mouthpiece cover, and the liquid inlet slit has a width L no less than 0.4 mm.

11. The electronic cigarette according to claim 10, wherein the fixing sleeve is sleeved on the connector and the liquid container.

12. The electronic cigarette according to claim 10, wherein an angle formed between the inclined air inlet and an axial direction of the connector is greater than 20 degrees and less than 70 degrees.

13. The electronic cigarette according to claim 10, wherein the heat generation mechanism comprises a liquid guiding wick, a heating wire, a liquid guiding cotton, and a ceramic supporting seat, the liquid guiding cotton is configured to temporarily store cigarette liquid adsorbed from the liquid container, the liquid guiding wick is configured to transfer the cigarette liquid on the liquid guiding cotton to the heating wire for atomization, and the heating wire is fixed on the ceramic supporting seat and is electrically connected to the connector.

14. The electronic cigarette according to claim 10, wherein at least one position limiting groove configured to limit a position of the fixing sleeve is provided on the connector at a portion where the connector and the fixing sleeve are connected.

15. The electronic cigarette according to claim 14, wherein the groove or the position limiting groove is an annular groove.

16. The electronic cigarette according to claim 10, wherein the width L of the liquid inlet slit is not less than 1 mm and not greater than 3 mm.

17. The electronic cigarette according to claim 10, wherein the observation window is a rectangular window; and
two ends of the rectangular window are arc-shaped.

18. The electronic cigarette according to claim 17, wherein the rectangular window is provided with a graduated scale.
